(19) United States
(12) Patent Application Publication
(10) Pub. No.: US 2021/0244618 A1
(43) Pub. Date: Aug. 12, 2021

(54) APPARATUS FOR THE MANUFACTURE OF SUPPOSITORIES AND METHOD OF USE

(71) Applicant: Glup LLC, Denver, CO (US)

(72) Inventor: Christina Spencer Bellman, Denver, CO (US)

(73) Assignee: Glup LLC, Denver, CO (US)

(21) Appl. No.: 17/172,642

(22) Filed: Feb. 10, 2021

Related U.S. Application Data
(60) Provisional application No. 62/975,125, filed on Feb. 11, 2020.

(51) Int. Cl. A61J 3/08

(52) U.S. Cl. CPC A61J 3/08

(57) ABSTRACT

The present invention is directed toward an apparatus and method for consumer manufacture of suppositories for rectal or vaginal delivery allowing for the removal of formed suppositories while mitigating the deformation or damage to the formed suppositories when removed.

### CROSS REFERENCE TO RELATED APPLICATIONS

This application claims the benefit of U.S. Provisional Patent Application 62/975,125 entitled “APPARATUS FOR THE MANUFACTURE OF SUPPOSITORIES AND METHOD OF USE” filed on Feb. 11, 2020; the entire contents of which are incorporated herein by reference in its entirety for all purposes.

### FIELD OF THE INVENTION

The present invention is directed toward the manufacture of suppositories generally intended for administering therapeutic, homeopathic, and medical treatments—typically administered rectally or vaginally.

### BACKGROUND OF THE INVENTION

The administration of medical or therapeutic compounds rectally or vaginally are used across numerous fields from alternative wellness to traditional medicine. Certain compounds are well accepted by certain communities to provide medical and/or therapeutic benefits when delivered rectally or vaginally. As a result, a growing population of consumers undertake the manufacture and administration of their own suppositories using medicines and compounds which they tailor to their own needs and preferences.

Rectal and vaginal delivery of compounds has been shown to bypass certain shortcomings of traditional medicines. Suppositories are commonly administered when a medication dose is difficult to swallow or is particularly hard on the digestive system. Suppositories can also be administered to bypass the liver to avoid any unwanted side-effects with certain medicines or compounds. For instance, the use of a medicinal Cannabis-based compound containing compounds such as Tetrahydrocannabinol, commonly known as “THC”, within a suppository allows a patient to benefit from the medicinal and therapeutic aspects of the marijuana plant without resulting intoxication of the individual. Other situations when suppositories are preferred over oral medical include: seizure medications if the patient cannot take the medication orally, difficulty in swallowing, nausea and vomiting wherein a patient is unable to hold down oral medication, blockages that prevent medication from moving through the digestive system, oral medication has unpleasant taste, orally administered medication would break down too rapidly in the gut or could be destroyed in the gastrointestinal tract.

Due to the increasing use of suppositories for a variety of conditions and ailments, consumers have increasingly begun to manufacture their own suppositories. The method of manufacturing one's own suppositories typically surrounds the preparation of a mixture in a fluid form having a mixture of compounds to form the suppository. In certain situations, the mixture must be heated in order to achieve a fluid state. The fluid is dispensed into a form which is then placed in a refrigerator or freezer for solidification through cooling. Once solid, a suppository can be removed from the mold and administered as desired.

After administration, the suppository dissolves melts and/or dissolves releasing the medication into the surrounding tissue and directly into the bloodstream.

### SUMMARY OF THE INVENTION

The present invention surrounds a method and apparatus for the manufacture of suppositories intended to increase ease of manufacture and cleanliness. Embodiments of the present invention as disclosed provide an apparatus for the manufacture of suppositories.

Certain existing apparatus and methods of manufacturing suppositories include the use of open molds offering a cavity which is top-filled through an orifice, wherein the orifice remains exposed to the ambient environment. This open orifice may cause for concern to some surrounding the cleanliness and quality control of the resultant suppository.

In is an aspect of the present invention to allow the manufacture of suppositories with minimal interface with the user, surfaces such as countertops and minimal exposure to air.

Certain existing apparatus and methods of manufacturing suppositories include the top-filling of multiple small cavities through each open-topped cavity. As a result, this compounds time for manufacture and increases the possibility of spilling the fluid for manufacturing suppositories during the manufacture process. Furthermore, since each cavity is individually filled, this results in a lack of consistency of suppository size within the same batch of suppositories.

It is an aspect of certain embodiments to include an aperture through which fluid is poured to fill multiple chambers. The aperture allows a user to fill multiple chambers with fluid evenly, thus resulting in a consistent amount of fluid delivered to each chamber, and resulting in a consistent suppository size. The filling of multiple chambers through one aperture improves time efficiency of the manufacture of suppositories and prevents spillage, thereby mitigating the wasting of prepared fluid. The filling of a multiple cavities through one aperture results in the even filling of each chamber, resulting in consistently sized suppositories within the same batch.

In certain embodiments, an apparatus includes a funnel for the direction of suppository material into an aperture to mitigate spillage of the suppository material.

In certain existing mold technologies, a user has no way to identify the level to which a mold should be filled or to what level the cavities are filled to. Sometimes sighting from above the mold is required, in other instances a user must rely on the practice of stopping the fill process once the mold overfills. This can result in a messy and wasteful filling process.

It is an aspect of certain embodiments to address the filling of a mold to limit messiness and waste. Certain embodiments comprising an apparatus include a fill-line which indicates to a user that the molds have been filled to a proper level. It will be appreciated that a fill-line as appreciate by those skilled in the art includes a protuberance or depression indicating the proper fill level. Other examples of a fill-line include, but are not limited to, translucent or transparent material allowing a user to see the level of fluid within a cavity through a surface. A fill-line indicates to a user when the mold is properly filled, thus mitigating pouring excess fluid into the mold.

It is an aspect of certain embodiments to indicate to a user when fluid used for manufacturing suppositories has become solid. In certain embodiments, the indication of temperature within the chambers of a mold indicate to a user the status of the fluid within the chamber. In certain embodiments, a color-changing indicator communicates to a user when the fluid has reached a particular temperature indicating proper solidification.

It is an aspect of certain embodiments to include a first mold side having a plurality of cavities and a second mold side having a plurality of cavities for the manufacture of suppositories. The first mold side and second mold side are configured in a clam-shell form such that when the clam-shell is in a closed configuration, the cavities of the first mold side align with the cavities of the second mold side to create a plurality of chambers. Furthermore, when the clam-shell is in a closed configuration, fluid disposed through the aperture to fill the plurality of chambers is prevented from leaking between the internal surface of the first mold side and the internal surface of the second mold side. In certain embodiments a plurality of cavities can be filled through one aperture. After the suppositories have solidified, the clam-shell can be opened to disengage the first mold side from the second mold side enabling the removal of suppositories.

An advantage to the filling of a plurality of cavities through one aperture includes consistency in composition of a plurality of suppositories from the same batch. A prepared mixture of suppository material in fluid form may be subject to settling or separation, resulting in a non-homogenous mixture. Delivery of a non-homogenous mixture to a plurality of cavities individually in sequence would result in a plurality of suppositories being inconsistent and result in a plurality of suppositories having dissimilar compositions. Inconsistency in the production of suppositories can be dangerous particularly with those using medicine. Inconsistency in the production of suppositories can result in some suppositories of a batch having more medicine than intended, and other suppositories within the batch not receiving enough medicine. The use of one aperture to fill a plurality of cavities results in each cavity receiving similar material composition even if the prepared mixture of suppository material is non-homogenous.

In certain embodiments, a funnel connected to an aperture in the top surface of a second mold side further mitigates spillage when delivering fluid through an aperture. A funnel allows a user to dispose fluid into an apparatus requiring less accuracy and allowing for higher flow rates.

It is an aspect of certain embodiments surrounding an apparatus to comprise a primer bulb. It will be appreciated that a primer bulb surrounds a volume, typically of a substantially hemispherical form, constructed of a flexible material. Depression of a primer bulb causes can be used to create positive pressure downstream from the primer bulb. In certain embodiments, releasing the primer bulb allows the primer bulb to rebound to its original form and cause negative pressure upstream of the primer. The use of a primer bulb in certain embodiments is used to assist in the complete filling of molds within the apparatus when filling.

In certain embodiments, the present invention is configured for use in conjunction with existing technologies such as disclosed in U.S. Pat. No. 9,795,246 to Bellman et al. (“the '246 patent”) for purposes such as to increase efficiency and repeatability in the manufacture of suppositories.

Surrounding the home manufacture of suppositories, there is concern expressed by some about the sanitary aspect of home manufacturing of suppositories in an unregulated surrounding such as a home kitchen. It is an aspect of the present invention to mitigate sanitary concerns by minimizing user contact with fluid suppository material or solid suppositories. In certain embodiments, an apparatus comprises an ejection mechanism which allows a user to remove molded suppositories from the apparatus without direct contact with the suppository. In certain embodiments, an ejection mechanism comprises a push-button having a first side exposed to the exterior of the apparatus, and a second surface in communication with a cavity. Thus, a user is able to eject the molded suppository without requiring direct contact with the suppository.

It is a further aspect of certain embodiments that an apparatus serves as a convenient storage container for suppositories until use, thus preventing damage from freezer burn and preventing jostling which may deform or damage the suppositories.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### BRIEF DESCRIPTION OF THE DRAWINGS

FIG. 1—A perspective view of certain embodiments in an open configuration

FIG. 2A—A cross sectional view of certain embodiments in a closed configuration

FIG. 2B—An enlarged view of certain embodiments comprising a push-button

FIG. 3A—A perspective transparent view of certain embodiments in a closed configuration

FIG. 3B—A perspective transparent view of certain embodiments in an open configuration

FIG. 4—Embodiments of a method for the manufacture of suppositories

### DETAILED DESCRIPTION OF VARIOUS EMBODIMENTS

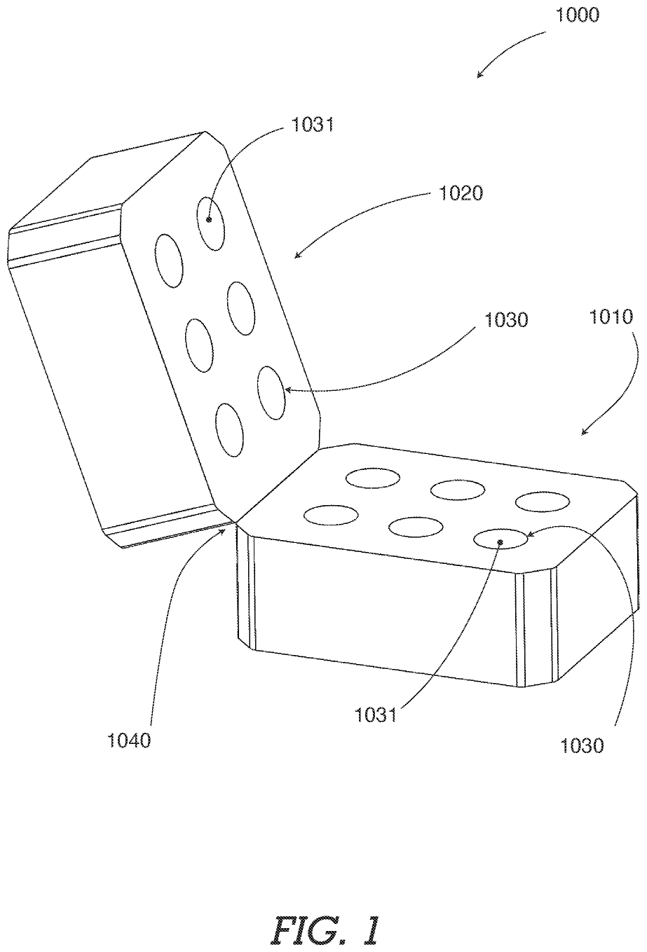

Certain embodiments, as seen in FIG. 1, comprising an apparatus 1000 for the manufacture of suppositories comprise a first mold side 1010 and a second mold side 1020. The first mold side 1010 having at least one cavity 1030 configured for the molding of a first side of a suppository. The cavity 1030 of the first mold side comprises an open end 1031 which is pen to the internal surface 3040 of the first mold side. The second mold side 1020 having at least one cavity 1030 configured to align with the cavity 1030 of the first mold side to form a second side of a suppository. The cavity 1030 of the second mold side comprises an open end 1031 which is open to the internal surface 3025 of the second mold side. In certain embodiments, the first mold side 1010 and the second mold side 1020 comprise a plurality of cavities 1030 which are configured to align when the first mold side 1010 and the second mold side 1020 are assembled.

In certain embodiments, shown in FIG. 1, a first mold side 1010 and a second mold side 1020 comprise a hinged connection 1040. A hinged connection 1040 of certain embodiments, as discussed herein, can comprise a hinge 1040 assembled from two or more elements configured to be rotatively adjustable about at least one axis. It will be further appreciated that a hinged connection 1040 of certain embodiments comprise a living hinge wherein the first mold side and the second mold side are interconnected by a flexible element or sheet of material.

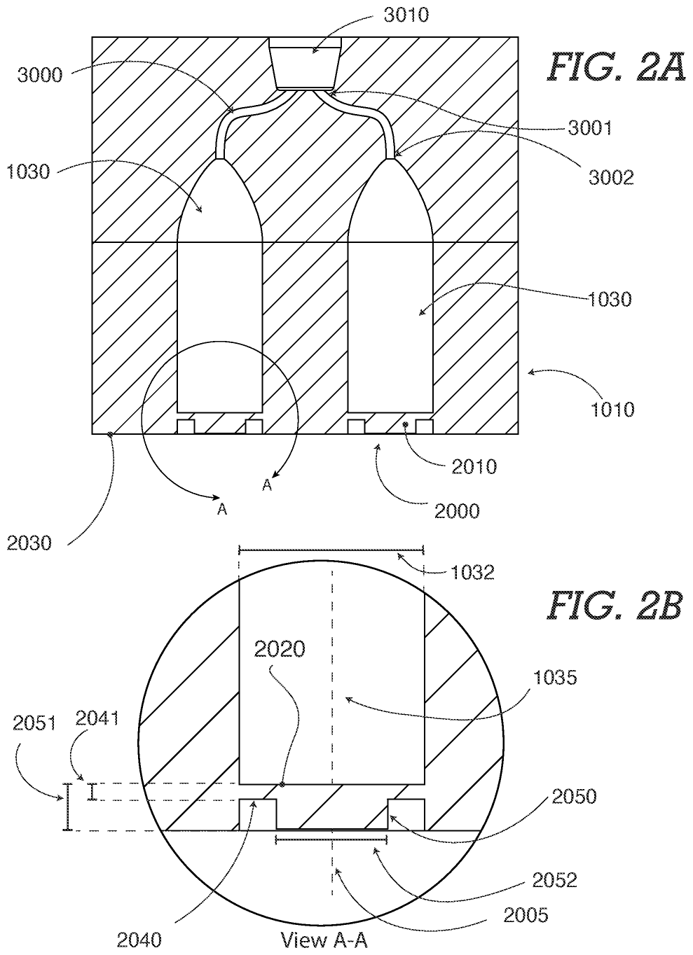

In certain embodiments comprising an apparatus 1000, as shown in FIG. 2A-FIG. 2B, a first side of a mold 1010 comprises a push-button 2000 for the removal of a suppository from the first mold side 1010. In certain embodiments, a push-button 2000 comprises a membrane 2010 between an internal cavity surface 2020 an external surface 2030 of the first mold side. The membrane 2010 comprises an elastic material allowing for deflection of the membrane 2010 into the cavity 1030. In certain embodiments a push-button 2000 comprises a membrane 2010 comprising a perimetral aspect 2040 and a central aspect 2050, wherein a thickness 2051 of the central aspect 2050 is comparatively thicker than a thickness 2041 of the perimetral aspect 2040. In certain embodiments, the central aspect 2050 comprises a width 2052 less that a width 1032 of the cavity of the first mold side. In such embodiments the thicker central aspect 2050 prevents the unintentional distortion of the shape of the suppository, while the thinner perimetral aspect 2040 deflects, thus resulting in the ejection of the suppository from the cavity 1030 of the first mold side. In certain embodiments, the push-button 2000 conforms with the bottom 2020 of the cavity of the first mold. Thus, the thicker central aspect 2050 of the push-button maintains the shape of the suppository and mitigates deformation of the suppository while being ejected. In certain embodiments, elements of the push-button 2000, such as the membrane 2010 of the push-button, comprises an elastic material such as silicone, rubber, or other elastomers known to those skilled in the art. In certain embodiments, a central axis 2005 of the push-button is colinear with a central axis 1035 of the cavity of the first mold side. It will be appreciated that as a cavity 1030 of the first mold side can comprise a number of profile shapes, such as circular, ovular, oblong or other shapes appreciated by those skilled in the art, the push button 2050 of certain embodiments comprises a similar profile to that of the cavity.

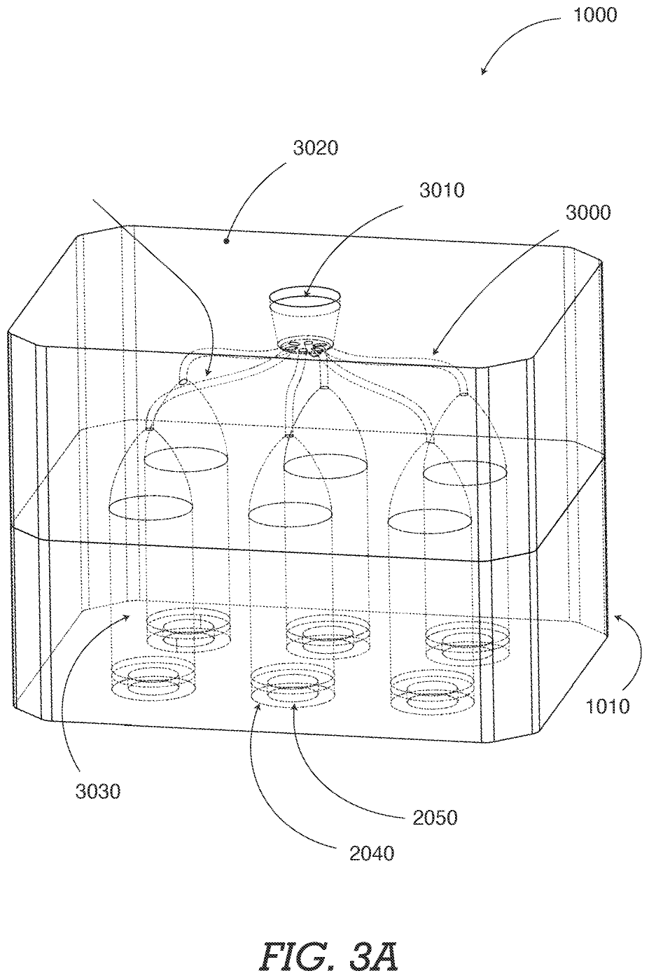

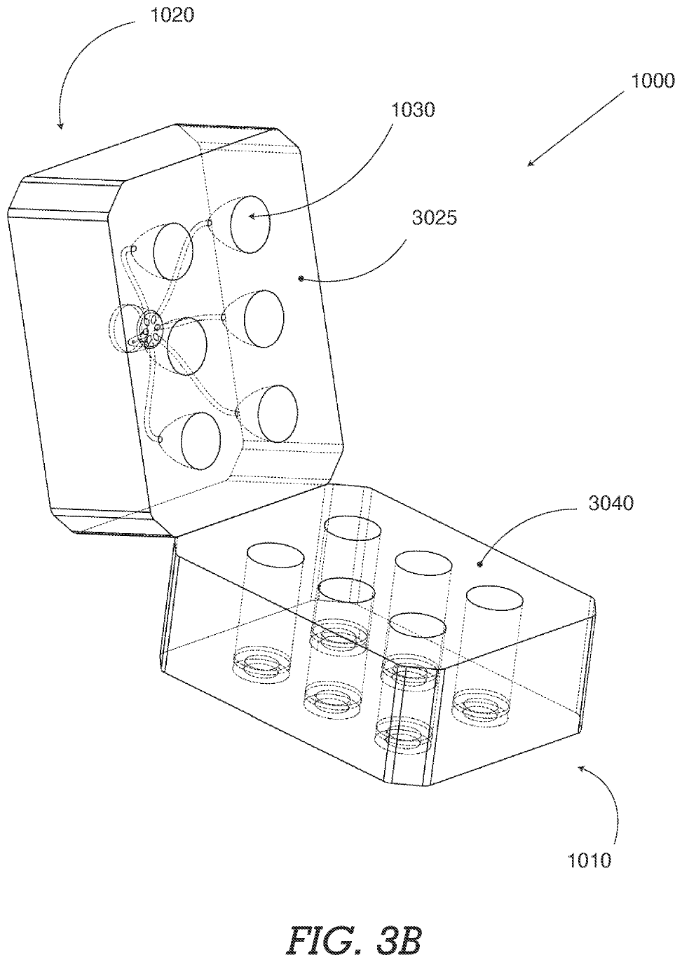

In certain embodiments, shown in FIG. 2A-FIG. 3B, a second mold side 1020 comprises a channel 3000 which directs fluid, such as suppository material, toward a cavity 1030 in the second mold side 1020. In certain embodiments, a plurality of channels 3000 direct fluid to a plurality of cavities 1030 in the second mold side. A first end 3001 of the channel is interconnected with the aperture 3010, and a second end 3002 of the channel is interconnected with the cavity 1030 of the second mold side. such embodiments, the second mold side 1020 comprises an aperture 3010 in an external surface 3020 of the second mold side. The aperture 3010 is in direct communication with at least one channel 3000. The channel 3000 traverses from the aperture 3010 to an internal surface 3025 of the second mold side. In certain embodiments the channel 3000 is in direct communication with a cavity 1030 of the second mold side. The channel 3000 is configured to carry fluid from the aperture 3010 to a cavity 1030 or to a plurality of channels 1030 configured to fill a plurality of cavities 1030. In certain embodiments, a plurality of channels 3000 in direct communication with the aperture are also in direct communication with a plurality of cavities 1030 in the second mold side, thus the channels 3000 are configured to carry fluid from the aperture 3010 to the plurality of cavities 1030 in the second mold side. As such, pouring fluid into the aperture 3010 from the external surface 3020 of the second mold side, results in the fluid passing through the aperture 3010 and into the channel 3000 to fill one or more chambers 3030. It will be appreciated that the channels 3000 of certain embodiments as discussed herein are configured to direct fluid flow to a plurality of cavities 1030 at the same time, thus resulting in the simultaneous filling of a plurality of chambers 3030.

In certain embodiments, referencing FIG. 3A-FIG. 3B, channels 3000 are encapsulated within the second mold side 1020 of an apparatus 1000. In alternate embodiments, channels 3000 can be encapsulated within the second mold side 1020 of the apparatus, in an internal surface 3040 of the first mold side, in an external surface 3020 of the second mold side, or a combination thereof while in keeping with the spirit and scope of the present invention. In certain embodiments, channels are configured to communicate with a cavity of the first mold side 1010. Furthermore, in certain embodiments, channels 2000 are configured to communicate fluid with a cavity of the first mold side 1010 thus allowing a chamber 3030 to be filled in a bottom-up filling process.

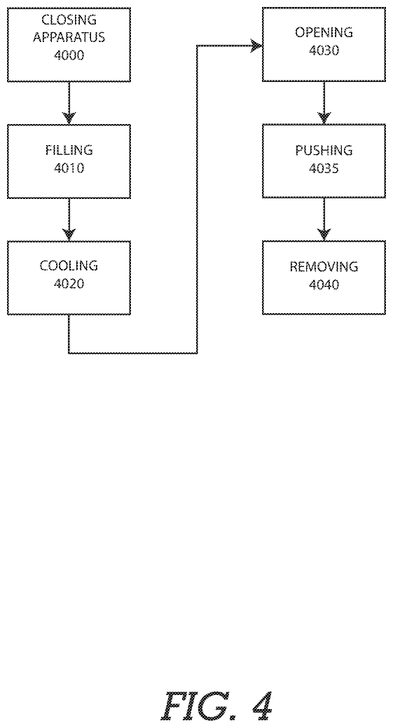

In certain embodiments, shown in FIG. 4, the method of manufacturing suppositories comprises closing 4000 an apparatus by engaging a first mold side with a second mold side thereby aligning the cavities of the first mold side with the cavities of the second mold side to form chambers. Following the closing 4000 of the mold, the filling 4010 step surrounds the pouring of fluid, such as prepared fluid for the manufacture of suppositories, into the chambers. In certain embodiments, the filling 4010 step comprises the pouring of fluid into an aperture having direct communication with a plurality of chambers. Following the filling 4010 step, the cooling 4020 step involves the decrease of temperature of the fluid until solid. Following the cooling 4020 step, the opening 4030 step involves disengaging the first mold side form the second mold side. Following the opening 4030 step, the pushing 4035 step involves the use of an ejection mechanism, such as a push-button, to advance the suppository upward from the first mold side which increases the ease of removal. For instance, with the use of a push-button having a membrane, a user disposes a finger on an exterior surface of the push-button and applies a force toward the cavity of the first mold side, resulting in the deflection of the push-button toward the cavity of the first mold side and thus ejecting the suppository from the cavity of the first mold side. Following the pushing 4035 step, the removing 4040 step surrounds the user pulling the formed suppository from the first mold side.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. An apparatus for the manufacture of suppositories comprising:
a first mold side and a second mold side;
the first mold side comprising a cavity, the cavity of the first mold side having an open end which is open to an internal surface of the first mold side;
the second mold side comprising a cavity, the cavity of the second mold side having an open end which is open to the internal surface of the second mold side;
the cavity of the first mold side and the cavity of the second mold side forming a chamber when the open end of the cavity of the first mold side and the open end of the cavity of the second mold side are interconnected;
an aperture in an external surface of the second mold side, a first end of a channel interconnected to the aperture, and a second end of the channel interconnected to the cavity in the second mold side;
wherein the first cavity of the first mold side, and the first cavity of the second mold side interconnect when the internal surface of the first mold side and the internal surface of the second mold side are interconnected, and
wherein the aperture is in fluid communication with the chamber.

2. The apparatus of claim 1 further comprising a push-button interconnected with an external surface of the first mold side, wherein the push-button is configured to deflect into the cavity of the first mold side when pressed.

3. The apparatus of claim 2, wherein the push-button further comprises a central aspect having a thickness, and a width less than a width of the cavity of the first mold side; and
a perimetral aspect extending radially outward from the central aspect, the perimetral aspect having a thickness less than the thickness of the central aspect.

4. The apparatus of claim 3, wherein the profile of the push-button is similar to that of the inner profile of the cavity of the first mold side.

5. The apparatus of claim 4, wherein a central axis of the push-button is collinear with a central axis of the cavity of the first mold side.

6. The apparatus of claim 1, wherein the first mold side comprises a plurality of cavities, the plurality of cavities of the first mold side having an open end which are open to the internal surface of the first mold side;
the second mold side comprise a plurality of cavities, the plurality of cavities of the second mold side having an open end which are open to the internal surface of the second mold side;
each of the plurality of cavities of the second mold side is interconnected to the aperture with a plurality of channels;
a first end of each of the plurality of channels is interconnected to the aperture, and a second end of the plurality of channels is interconnected to the plurality of channels of the second mold side;
the plurality of cavities of the first mold side and the plurality of cavities of the second mold side forming a plurality of chambers when the open ends of the plurality of cavities of the first mold side and the open ends of the plurality of cavities of the second mold side are aligned with each other;
wherein the plurality of cavities of the first mold side, and the plurality of cavities of the second mold side align when the internal surface of the first mold side and the internal surface of the second mold side are interconnected, and
wherein the aperture is in fluid communication with the plurality of chambers.

7. The apparatus of claim 6, wherein each cavity of the first mold side comprises a push-button interconnected with an external surface of the first mold side, wherein the push-buttons are configured to deflect inward into the plurality of cavities of the first mold side.

8. The apparatus of claim 7, wherein the push-buttons each further comprise a central aspect having a thickness, and a width less than a width of the cavity of the first mold side; and
a perimetral aspect extending from the central aspect outward, the perimetral aspect having a thickness less than that of the central aspect.

9. The apparatus of claim 8, wherein the profile of the push-button is similar to that of the inner profile of the plurality of cavities of the first mold side.

10. The apparatus of claim 9, wherein a central axis of the push-buttons is colinear with a central axis of the plurality of cavities of the first mold side.

11. The apparatus of claim 10, wherein the first mold side and the second mold side are hingedly interconnected.

12. An apparatus for the manufacture of suppositories comprising:
a clam-shell comprising a first mold side and a second mold side;
a first mold side having a plurality of cavities, an open side of the cavities in communication with an internal side of the first mold side;
a second mold side having a plurality of cavities, an open side of the cavities in communication with an internal side of the second mold side, and the cavities of the second mold side configured to align with the cavities of the first mold side;
the alignment of the cavities of the first mold side with the cavities of the second mold side creating a plurality of chambers;
an aperture in communication with an external side of the second mold side;
a plurality of channels each with a first end interconnected to the aperture, and a second end of the plurality of channels interconnected to the plurality of cavities of the second mold side;
each of the plurality of cavities of the second mold side comprising a push-button interconnected to a bottom surface of the plurality cavities; and
the plurality of push buttons comprising a membrane having a thin perimetral aspect and a thick central aspect,
wherein when the clam-shell is in a closed configuration, disposal of a fluid into the aperture results in the flow of fluid through the plurality of channels into the plurality of chambers; and
wherein following solidification of the fluid, depression of the plurality of push-buttons results in ejection formed objects from the plurality of cavities on the first side of the mold.

13. A method for manufacturing suppositories comprising:
closing an apparatus by interconnecting an internal side of a first mold side with an internal side of a second mold side, wherein a cavity of the first mold side aligns with a cavity of the second mold side to form a chamber;
filling the chamber with a fluid through an aperture interconnected with an external surface of the second mold side;
cooling the apparatus until the fluid become a solid, resulting in a formed object within the chamber;
opening the apparatus, by separating the internal side of the first mold side from the internal side of the second mold side;
pushing a push-button configured to extend upward into the cavities of the first mold side;
removing the formed objects from the first mold side.
